(19) United States
(12) Patent Application Publication
(10) Pub. No.: US 2026/0185948 A1
(43) Pub. Date: Jul. 2, 2026

(54) METHOD AND SYSTEM FOR DETECTION OF BEVEL EDGE

(71) Applicant: Onto Innovation Inc., Wilmington, MA (US)

(72) Inventor: Robert Davis, Wilmington, MA (US)

(73) Assignee: Onto Innovation Inc., Wilmington, MA (US)

(21) Appl. No.: 19/005,641

(22) Filed: Dec. 30, 2024

(51) Int. Cl. G01N 21/95; G01N 21/88; G06T 7/00; G06T 7/13; G06T 7/50

(52) U.S. Cl. CPC G01N 21/9503; G01N 21/8851; G06T 7/0006; G06T 7/13; G06T 7/50; G01N 2021/8877; G01N 2021/8887; G06T 2207/20024; G06T 2207/20081; G06T 2207/30148

(57) ABSTRACT

The present application provides a method and system of detecting a presence and location of a beveled edge of a substrate. The disclosure utilizes a kernel to accurately identify the boundary between a surface zone and a beveled edge on a substrate. The method comprises moving the substrate in an inspection tool; capturing, at the inspection tool and in digital form an initial image of the beveled edge of the substrate; generating a filtered image by filtering the initial image using a kernel having a shape substantially matching an expected shape of the beveled edge; and identifying a line in the filtered image representing the beveled edge by applying a line detection algorithm to the filtered image.

### TECHNICAL FIELD

The present disclosure is directed to a method and system of detecting presence of a beveled edge of a substrate. More particularly, the method and system uses software to identify the boundary between a surface zone and a beveled edge on a substrate.

### BACKGROUND

The semiconductor fabrication process requires precise and accurate inspection methods to ensure the quality, yield and functionality of the produced components. Particularly, in semiconductor manufacturing, accurately detecting the boundary between a substrate's primary surface zone and its bevel edge zone is important. For example, the boundary between substrate zones such as the central area, edge zone, and bevel edge is useful for accurate metrology, as each zone has unique characteristics and potential defects that could possibly impact the substrate quality and yield. The boundary between these zones therefore, needs accurate identification to ensure that measurements are precisely targeted, to help detect defects and maintain process alignment. However, it is challenging to identify this boundary in positioning, alignment, and image registration. Limitations arise due to various factors including bevel edge's variable characteristics, debris and particles accumulating at the edge, defects like chips or cracks near the bevel edge and block the exact boundary lines, etc. These factors create noise and false signals, leading to errors in edge detection, and reducing the precision of metrology efforts in semiconductor production. Hence, there is a desire for an enhanced method to detect the beveled edge accurately, to enhance metrology accuracy, and thereby enabling more precise substrate alignment and feature localization, thus supporting high-quality and efficient semiconductor manufacturing.

### SUMMARY

One aspect of the present disclosure provides method of detecting a presence and location of a beveled edge of a substrate. The method comprising of, moving the substrate in an inspection tool; capturing, at the inspection tool and in digital form an initial image of the beveled edge of the substrate; generating, a filtered image by filtering the initial image using a kernel having a shape substantially matching an expected shape of the beveled edge; and identifying, a line in the filtered image representing the beveled edge by applying a line detection algorithm to the filtered image.

Another aspect of the present technology provides a computer readable storage medium storing processor-executable instructions configured to, when executed by at least one processor, cause performance of a method of detecting a presence and location of a beveled edge of a substrate, the method comprising: receiving, at a semiconductor inspection tool and in digital form, an initial image of the beveled edge of the substrate; generating, by a processor of the semiconductor inspection tool, a filtered image by filtering the initial image using a kernel having a shape substantially matching an expected shape of the beveled edge; and identifying, with the processor, a line in the filtered image representing the beveled edge by applying a line detection algorithm to the filtered image.

Another aspect of the present technology provides a system for detecting a presence and location of a beveled edge of a substrate. The system comprising: a substrate moving mechanism; an imaging system configured to capture an initial digital image of the beveled edge of the substrate; and processing circuitry configured to: receive the initial digital image; generate a filtered image by filtering the initial image using a kernel having a shape substantially matching an expected shape of the beveled edge; and identify a line in the filtered image representing the beveled edge by applying a line detection algorithm to the filtered image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 is a flowchart illustrating operations in method of detecting a presence and location of a beveled edge of a substrate, in accordance with an embodiment of the disclosure.

FIG. 2A is an image depicting a substrate, in accordance with an embodiment of the disclosure.

FIG. 2B is an image depicting a beveled edge of a substrate, in accordance with an embodiment of the disclosure.

FIG. 3A is an image depicting a region of interest (ROI) from a top-surface scan of a substrate and a filtered image, in accordance with an embodiment of the disclosure.

FIG. 3B is an image depicting a region of interest (ROI) from a bottom-surface scan of a substrate and a filtered image, in accordance with an embodiment of the disclosure.

FIG. 4 is an image depicting system for detecting a presence and location of a beveled edge of a substrate, in accordance with an embodiment of the disclosure.

FIG. 5 schematically depicts a computer readable storage medium configured to execute instructions configured to detect a presence and location of a beveled edge of a substrate, in accordance with an embodiment of the disclosure.

### DETAILED DESCRIPTION

In general terms, a method of detecting a beveled edge of a substrate and a system thereof is described. For example, a presence and location of a beveled edge of a substrate is identified using bevel edge images captured by at least one camera or multiple cameras in different angles. The bevel edge detection method identifies the attributes of the bevel edge, including bevel angles, bevel geometry, and bevel location. The method further detects variations in bevel edge, such as irregularities or misalignments that is indicative of defects. The captured bevel edge images in accordance with the present disclosure, allow to accurately measure the bevel's width and angle, helping to ensure that the substrate meets the specifications. This is useful in ensuring the structural integrity and high manufacturing quality and yield, as defects can lead to breakage, contamination, or functional limitations in the final product.

A semiconductor wafer or wafer is generally a flat discoid object of varying diameter. Semiconductor wafers are generally formed of a semiconductor material such as silicon, gallium arsenide, and the like, though in some instances Glassell composite materials such as epoxy can be used. In some embodiments, the semiconductor wafer can include an orientation structure such as a notch, mark, flat or other structure. Such semiconductor wafers frequently have a diameter of between about 200 mm and about 300 mm, but other sizes of semiconductor wafers are also common.

A semiconductor panel is generally a flat object made of semiconductor materials, glass, or composite materials. Semiconductor panels typically have a rectangular or square shape and come in a variety of sizes, although there are common sizes referred to as “generations” with specific dimensions follow: Gen. 1:300×400 mm; Gen. 2:360×465 mm; Gen. 2.5:400×500 mm; Gen. 3:550×650 mm; Gen. 3.5:620×750 mm; Gen. 4:730×920 mm; Gen. 5:1100×1300 mm; Gen. 6:1500×1850 mm; Gen. 7:1870×2200 mm; Gen. 7.5: 1950×2200 mm; and Gen. 8:2200×2500 mm. Advanced integrated circuit substrates (AICS) may have the following dimensions: 510×515 mm; or 600×600 mm. In some embodiments, the semiconductor panel can be in the form of a copper core laminate (CCL) panel, etc. In some embodiments, the semiconductor panel can be a glass panel substrate, or other panel constructed of soda-lime glass treated with one or more special coatings to improve the adhesion and uniformity of deposited materials.

A substrate is layer that includes material such as silicon (or other semiconductor material), glass, or any other material, such as a substrate of a panel or a wafer. In some embodiments, either a wafer or a panel can serve as a base upon one or more layers of material are applied and processed to create a multilayered semiconductor substrate. For example, the one or more layers can include one or more redistribution layers, which may include conductive traces, interspaced between insulative, dielectric layers. Through holes can be defined in the wafer or a panel to enable communication between layers applied to opposing major surfaces of the wafer or a panel.

In some embodiments, the substrate can include an array of repeated functional units, each of which can represent a portion of a semiconducting substrate on which a given functional circuit is fabricated. For example, in one non-limiting example, the functional circuit can take the form of a central processing unit. In some embodiments, additional electrical components can be electrically coupled to the semiconductor panel to complete the functional unit. In other embodiments, the layered semiconductor panel itself can represent a completed functional unit.

An inspection tool generally refers to equipment used to carry out non-destructive inspection of the substrate during or after manufacture. By way of non-limiting example, the inspection process can include runtime scanning (in a single or in multiple scans), sampling, reviewing, measuring, classifying and/or other operations provided with regard to the substrate or parts thereof using the same or different inspection tools. Likewise, at least partial inspection can be carried out prior to manufacture of the substrate to be examined, and can include, for example, generating an inspection recipe(s), training respective classifiers or other machine learning-related tools and/or other setup operations. It is noted that, unless specifically stated otherwise, the term “inspection tool” or its derivatives used in this specification, is not limited with respect to resolution or to the size of an inspection area. A variety of non-destructive inspection tools includes, by way of non-limiting example, scanning electron microscopes, atomic force microscopes, optical inspection tools, etc.

A region of interest (ROI) refers to a specifically defined area within an image of the substrate that is inspected for bevel edge detection. The image of the substrate may be divided into multiple regions of interest, wherein each ROI is analyzed separately using the bevel edge detection method. Selecting an ROI for separate bevel edge detection, facilitates targeted analysis using advanced image processing techniques and machine learning algorithms, resulting in enhanced bevel edge identification and improved yield in semiconductor manufacturing process. The image may be a scan line image.

Convolutional or convolutional operation may be used interchangeably, refers to transforming the pixels within its receptive field into a single value. In some embodiments, it can be applying a convolution to an image reduces its dimensions while combining the information within the receptive field into a single pixel. The result of the convolutional layer is typically an output vector.

A kernel refers to a mathematical operation or algorithm. The kernel may be a matrix applied to modify the pixel values of an image, particularly the beveled edge image of the substrate. In image processing, the kernel can be slid across each scan line of the image, and at each position, a dot product is calculated between the kernel and the pixel values of the image. Each pixel value under the kernel is multiplied by the corresponding kernel value, and the results are summed, wherein sum of these products at each position is known as the correlation value. A negative correlation value, in particular, may highlight an edge where the pixel values are decreasing, signifying the transition from a brighter region (the exposed part of the substrate) to a darker region (the bevel). In some embodiments the kernel matrix is applied to produce effects such as blurring, sharpening, embossing, and accurate beveled edge detection. A customizable kernel in the context of image processing refers to a matrix (or array) of values that can be adjusted based on specific requirements of the image analysis task.

Brightfield illumination refers to a microscopy technique where the light is transmitted onto the substrate to create a contrast image having dark features against a bright background. The initial image as per the present disclosure is an image captured in brightfield illumination, where the edge features appear in darker in a bright background, thereby making edge detection easier during substrate inspection.

Filtered image refers to an end image obtained as a result of applying a filtering operation on an initial image using a particular kernel. The filtered image precisely represents a beveled edge of a substrate by enhancing the transition edges and suppressing other non-relevant areas.

A line detection algorithm refers to a technique in image processing, used to identify lines in an image by collecting and analyzing edge points, to find the lines on which these edge points lie.

A surface region or primary zone can be used interchangeably, refer to a flat surface of the substrate before transitioning to a slanted or rounded edge of the substrate.

A confidence value refers to the degree of certainty that a line detected using a line detection algorithm, actually represents the bevel edge. As per present disclosure, a higher confidence value suggests that the detected line actually corresponds to a bevel edge and a lower confidence value indicates otherwise. The confidence value aids in filtering out non-relevant lines by ensuring only vertical lines with a high degree of certainty are considered valid.

Embodiments described herein may relate to a method of detecting a bevel edge of a substrate. Multiple and adaptive or dynamic operation modes may be used to provide a system for bevel edge detection in semiconductors or substrates. Embodiments of the system, and methods thereof, may be widely applicable to different types of substrates, processing, and equipment.

According to one aspect of the present disclosure, a method of detecting a presence and location of a beveled edge of a substrate is disclosed. The method comprises of utilizing a digital form of an initial image of the beveled edge of the substrate, for generating a filtered image, by filtering the initial image using a kernel having a shape substantially matching an expected shape of the beveled edge. Further, a line in the filtered image representing the beveled edge is identified by applying a line detection algorithm to the filtered image. The embodiments disclosed in accordance with the present disclosure, utilize an optimized approach by inventors to enhance the accuracy in identifying the precise boundary between a surface region or a primary zone and the bevel zone. The method as disclosed can increase the metrology accuracy, thereby enabling more precise substrate alignment and feature localization, thus supporting high-quality and efficient semiconductor manufacturing. Beneficially, the method disclosed in accordance with the present disclosure allows to accurately detect the beveled edge in spite of noise, debris, and reflectivity issues. Further, beneficially, the method allows for enhanced metrology accuracy, thereby enabling precise substrate alignment and feature localization, thus supporting high-quality and efficient semiconductor manufacturing.

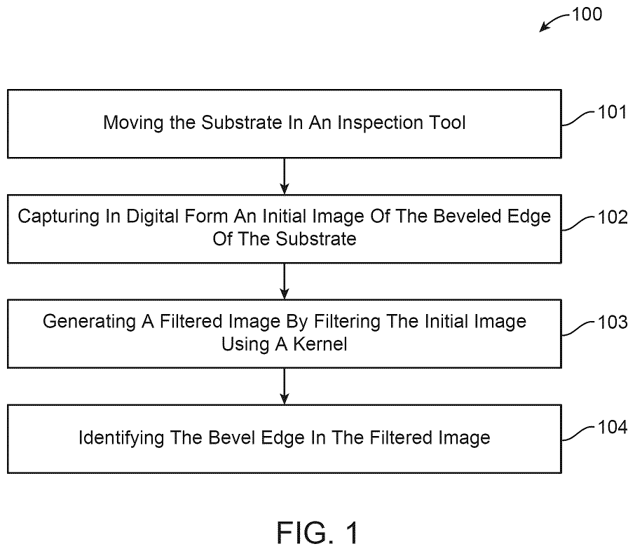

Referring to FIG. 1, the method 100 of detecting a presence and location of a beveled edge of a substrate is disclosed. The method comprises step 101 of, moving the substrate in an inspection tool. The substrate is moved in the inspection tools using a conventionally known automated process to ensure precision and prevent contamination. The substrates, typically stored in cassettes are placed on the inspection tool's load port, where their identifiers are scanned. A robotic arm precisely transfers the substrate, handling them by the edges, to a pre-aligner that orients them based on a notch or flat. The substrate is then positioned on secured on a chuck, or stage assembly in the inspection chamber, where fine alignment ensures sub-micron accuracy.

The method 100 comprises step 102 of, capturing, at the inspection tool and in digital form, an initial image of the beveled edge of the substrate. The inspection tool, can include a digital imaging system, which in some embodiments includes one or more image sensors. The image sensors present in the imaging system are any one or a combination of time delay integration (TDI) camera, area scan camera, hyperspectral camera or other sensor types as desired. In some embodiments, the digital imaging system can optionally include one or more lenses. For example, in some embodiments, the one or more lenses can serve to magnify an image of the substrate.

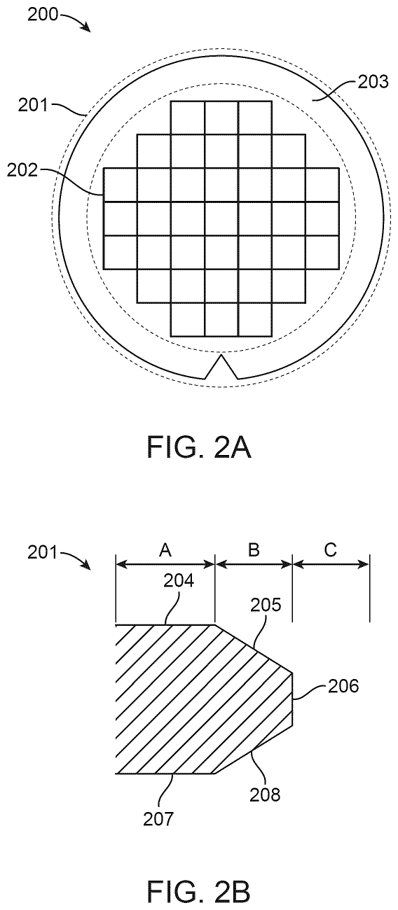

Referring to FIG. 2A, illustrates an embodiment in accordance with the present disclosure, 200A indicating a top view of the surface of a substrate 200. The substrate 200, has a plurality of chips 202 formed on the inner peripheral portion other than the bevel edged portion 203. The beveled edge portion 203 of the substrate edge 201 is schematically illustrated as a ring-shaped region with dashed lines. In this example, the beveled edge portion has a notch at one location.

Referring to FIG. 2B, that illustrates an embodiment in accordance with the present disclosure, 200B indicating a vertical cross-sectional view of the beveled edge portion 203. In the cross-sectional view of FIG. 2B, the surface of the substrate edge 201 has a substrate upper surface region 204 (or primary surface), a substrate upper bevel region 205, a substrate lower surface region 207 (or primary surface), a substrate lower bevel region 208 and an edge normal region 206 in this order from the inner peripheral side to the outer peripheral side in the X-axis direction, which is the radial direction. Each of these regions has different inclinations when viewed in a cross-section that includes the Z-axis, as shown.

In addition, when viewed from the Z-axis direction corresponding to the top view in a bevel image obtained by capturing the substrate surface from the Z-axis direction corresponding to the top view, the upper surface regions are sequentially arranged from the inner peripheral side to the outer peripheral side A, an upper bevel region B, and a background region C. In some embodiments of the present disclosure, these regions are defined by names such as substrate upper surface region 204 and upper surface region A for the sake of explanation, but are not limited to these. The area located on a plane parallel to the horizontal X-axis and Y-axis directions, corresponding to the inner peripheral portion of the substrate excluding the narrow bevel region, forms the substrate upper surface region 204 (or primary surface). The area corresponding to the narrow bevel region inclined at a specific angle with respect to the directions of the X-axis and the Y-axis forms the substrate bevel region 205. Furthermore, the region corresponding to the edge of the substrate 200, perpendicular to the substrate upper surface region 204, forms the substrate edge normal region 206.

In accordance with the present disclosure, the initial image of the beveled edge of the substrate captured by the digital imaging system comprises a pixel array. In general terms, the pixel array comprises a plurality of pixels arranged in an array, with the pixel array having a first dimension X and a second dimension Y. Each pixel of the pixel array has an associated pixel characteristic value, such as a brightness value, with substrate features, such as the first resist edge, the exposed edge region, the first resist edge, the substrate upper surface region 204, the substrate upper bevel region 205, the substrate lower surface region 207, substrate lower bevel region 208 and substrate edge normal region 206 causing variations in the pixel characteristic values.

Pixel characteristics optionally include grayscale brightness information, although other types of information, color data, for example, are also contemplated. For example, some embodiments include using a filter or other means to acquire red, blue, and/or green light intensity image data. Additionally, or alternatively, combinations of grayscale and color data, such as red, blue, and/or green data is optionally acquired and analyzed, for example using a Bayer camera. Additionally, it is contemplated that a pixel characteristic value optionally corresponds to a height value of the pixel in some embodiments. From the above, it should be understood that a variety of types of pixel characteristic values are contemplated, including those associated with any pixel characteristics that are representative of one or more substrate features.

In some embodiments, the first dimension X of the pixel array is substantially tangential to substrate edge 201, and in bevel edge portion 203, with the dimension Y being substantially radially aligned to the substrate edge 201, although other orientations of the pixel array are also contemplated, or may result due to substrate offset during inspection, for example. In one embodiment, the pixel array comprises an array of 1,600 horizontal pixels across the first dimension X by 1,200 vertical pixels across the second dimension Y (1,920,000 pixels), although other pixel arrays are contemplated. For example, the pixel array is optionally 1,920 pixels across the first dimension X by 1,078 pixels across the second dimension Y (2,069,760 pixels).

The method 100 further comprises step 103 of, generating, a filtered image by filtering the initial image of the beveled edge of the substrate using a kernel. The kernel performs image filtering by applying a mathematical operation to each pixel in the image and its neighbors. The kernel used for generating the filtered image can be a customizable kernel for performing one-dimensional convolution operation. The kernel may be modified in terms of its size, shape, and values, depending on the desired result. In accordance with the embodiments, the kernel is adjusted to highlight specific features such as transitions or edges in the initial image of the substrate, based on subtle variations in pixel intensity in the bevel edge portion. In an example embodiment, the kernel may have a total negative value, which is used for detecting bevel edges by highlighting areas of transitions having sharp contrast.

In accordance with the present disclosure, the kernel is a one-dimension kernel, having between three and twenty elements of increasingly negative value. The kernel filters the initial image of the bevel edge, by sliding over the image and scanning each pixel along with its adjacent pixels in each scan line present in the image. As per the present disclosure the kernel has a total negative value, which benefits in identifying areas of edge transitions based on pixel intensity variations. In one embodiment a significant contrast between the adjacent pixels where the pixel brightness drops or increases sharply indicates the presence of the bevel edge.

In some embodiments, the kernel has a shape substantially matching an expected shape of the beveled edge. The kernel has a series of values designed to match the shape of the expected transition indicating the bevel edge. This is particularly beneficial, in cases of considerable ambiguity in pixel variations representing the edge transitions, the customizable kernel can flexibly accommodate these variations while still accurately defining the transition point. As per the present disclosure, the transition is from the brighter intensities of the surface into either darker intensity in the bevel, or a fade to black when the bevel is not imaged, the kernel starts with more positive and increasingly negative values. The total value of the kernel is maintained negative to suppress the random variations in the field of the surface.

In an example embodiment, the bevel edge is expected to have a linear or gradual slope and the kernel is customized to match the pixel intensity variations depicting the expected linear or gradual slope of the bevel edge. The kernel may have positive and negative values arranged in a pattern that matches the expected pixel intensity variations defining the bevel edge transition.

In an embodiment, generating the filtered image further comprises computing a correlation with the kernel, for each scan line of the initial image. The computed correlation is a measure of degree of similarity between the kernel and the specific area in the image. The correlation value is higher (in magnitude) when the kernel matches with the area of the image which has an identifiable transition, indicative of the presence of the bevel edge. As per the present disclosure, the correlation value is computed for each scan line, generating a series of correlation values across the image, in which the highest value indicates the location of the bevel edge. This allows the method to accurately identify the presence and location of the bevel edge based on the intensity variations highlighted by the customizable kernel.

In accordance with the present disclosure, the filtered image generated using the one-dimensional kernel has highlighted values for a region of significant intensity variations, while the other areas with random intensity variations are considered as zero and suppressed. In a beneficial embodiment, the filtered image contains largely zero-valued pixels, except for a bright, often saturated line with significant intensity variation, that corresponds to the transition region with a slope which is identified as the bevel edge.

In some embodiments, the kernel is a first kernel, and wherein the method further comprises computing, for each scan line of the initial image, a respective correlation with each of a plurality of kernels including the first kernel. As per the present disclosure, the plurality of kernels differs in shapes, matching the various expected shapes of the bevel edge of the substrate, resulting in defined areas depicting the intensity variations indicative of the presence of the bevel edge.

The method of detecting the presence and location of a beveled edge of a substrate further comprises of comparing a respective correlation for a respective kernel of the plurality of kernels with the threshold value indicating a match to the respective kernel. In some embodiments, subsequent to computing a respective correlation with each of a plurality of kernels for each scan line of the initial image, each respective correlation for a respective kernel of the plurality of kernels is compared with a threshold value. The threshold value functions as a predetermined reference value for determining whether the correlation value for a particular kernel from the plurality of kernels matches the expected bevel edge characteristics. In one embodiment, if the comparison results in a higher correlation value, it indicates that the particular kernel matches the expected shape of the bevel edge of the substrate. Each of the kernel correlation is compared against the threshold value, to identify the specific kernel from the plurality of kernels which most accurately matches the expected shape of the bevel edge, thereby eliminating false positives and ensuring the reliability of the method.

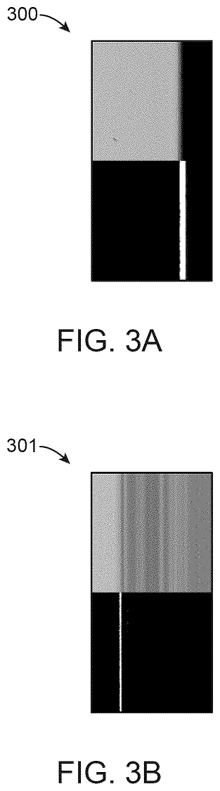

In a detailed implementation embodiment, as per the present disclosure FIG. 3A depicts a region of interest (ROI) 300 from a top-surface scan of a substrate in bright field illumination along with its generated filtered image, in accordance with an embodiment of the disclosure. As per the present disclosure, the (ROI) from a top-surface scan of a substrate has a sudden and clearly defined transition from bright to dark, resulting in a filtered image (bottom part of FIG. 3A) having a highlighted bright stripe that indicates the presence of the bevel edge at that location.

In another detailed implementation embodiment, as per the present disclosure FIG. 3B is an image depicting a region of interest (ROI) 301 from a bottom-surface scan of a substrate in bright field illumination along with its generated filtered image. As per the present disclosure, line scan image of ROI of the substrate has an expected transition with considerable ambiguity without a defined slope, the bright area towards the left depicts the substrate upper surface and the “striped” darker parts to the middle and right depicts the transition at the bevel edge. In the filtered image (bottom part of FIG. 3B) generated using the one-dimensional kernel matching the expected shape of the bevel edge, the point at which the darker stripes begin is highlighted and the remaining parts are dark region with zero pixels. This highlighted bright stripe indicates the presence of the bevel edge at that location. This method benefits in achieving accurate bevel edge detection by eliminating background noise.

The method 100 of detecting a presence and location of a beveled edge of a substrate, further comprises step 104 of (FIG. 1), identifying, a line in the filtered image representing the beveled edge by applying a line detection algorithm to the filtered image. The identified line can then be used for inspecting for defects or other substrate processing steps. As per present disclosure, the line detection algorithm is applied, in response to the comparison of a respective correlation for a respective kernel of the plurality of kernels with the threshold value. The line detection algorithm analyses the filtered image generated using the kernel, for the presence of straight lines which indicates the bevel edge. The line detection algorithm identifies straight line and generates a confidence value for each line. This confidence value is a measure of likelihood that the identified line corresponds to a bevel edge. In addition to, generating the confidence value, the line detection algorithm also generates the location of the straight line. The line detection algorithm may be chosen from, but not limited to Hough transform, Sobel and Prewitt Operators, RANSAC (Random Sample Consensus), Least Squares Regression methods. In some embodiments, the line detection algorithm is Hough transform.

In some embodiment, applying the line detection algorithm comprises applying a Hough Transform to the filtered image, wherein the Hough transform is configured to identify vertical lines representing the bevel edge in the filtered image. The Hough transform scans the image to identify straight lines and accepts vertical or near-vertical lines with higher confidence values. For a given location in ROI, any interruption in the line, the Hough transform outputs a “no value”, thereby enhancing reliability of the bevel edge detection method.

In accordance with one embodiment, applying the Hough Transform to the filtered image further comprises checking the pixel intensity values adjacent to the identified vertical line for verifying the bevel edge. As per the present disclosure, the adjacent pixel intensity values preferably include the values present at the immediate right to the identified vertical line during the front and back scans or the surface scans. In the event of absence of the expected pixel intensity values the identified vertical line in a given location in ROI, is discarded as untrustworthy.

The Hough transform generates both a confidence value and location for each of the identified vertical or near vertical lines. Each of scan line in the filtered image contributes to a vote and the sum of votes for a line representing a bevel edge is to be nearly unanimous. In the presence of debris or any defect resulting in a significant deviation, the identified vertical line is ignored for subsequent steps of semiconductor fabrication, thereby ensuring bevel edge detection with high reliability even in the presence of noise or debris.

As per the present disclosure, the method of detecting a presence and location of a beveled edge of a substrate further comprises, generating a report identifying defects in the substrate and locations of the defects relative to the beveled edge of the substrate. The report generated may include different types of visual and quantitative data providing comprehensive analysis relating to the location of bevel edge, distribution of defect types, confidence values for each of the identified vertical lines etc., in the form of histograms, charts or tables.

In a beneficial embodiment, the method of detecting a presence and location of a beveled edge of a substrate comprising generating a filtered image by filtering the initial image using a kernel having a shape substantially matching an expected shape of the beveled edge and subsequently using Hough transform to identify a line in the filtered image representing the beveled edge, provides effective edge identification while being flexible enough to work across many variables that are endemic to substrate edges. Furthermore, the method is repeated at hundreds of locations around a perimeter of the substrate, ensuring accuracy and redundancy of the method.

According to another aspect of the present disclosure, a system for detecting a presence and location of a beveled edge of a substrate, is disclosed. The system comprises of a substrate loading mechanism, an imaging system and a processing circuitry. As per the present disclosure, the imaging system is configured to capture an initial digital image of the beveled edge of the substrate. The processing circuitry is configured to receive the initial digital image; generate a filtered image by filtering the initial digital image using a kernel having a shape substantially matching an expected shape of the beveled edge; and identify a line in the filtered image representing the beveled edge by applying a line detection algorithm to the filtered image.

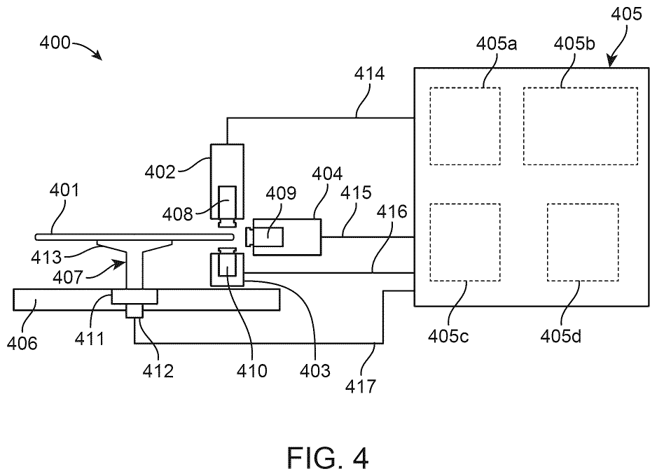

FIG. 4 illustrates an image depicting system for detecting a presence and location of a beveled edge of a substrate, in accordance with an embodiment of the disclosure. The system 400 comprises of a loading mechanism for loading the substrate 401 onto the stage 407. The substrate 401 is loaded into the stage 407 using conventionally known automated process to ensure precision and prevent contamination. A robotic arm precisely transfers the substrate onto the stage, handling them by the edges, to a pre-aligner that orients them based on a notch or flat. The stage assembly 406 includes a motor 411, an encoder 412, a stage 407, and a support plate 413. The motor 411 is coupled to the encoder 412 and the support plate 413, such that the motor 411 is adapted to rotate the support plate 413. The support plate 413, supports the substrate 401 during rotation and imaging of the substrate 401. The encoder 412 provides counts for controlling the position of motor 411 (and thus the support plate 413), although other methods/apparatuses for controlling a position of the motor 411 are contemplated.

The system 400 further comprises of an imaging system configured to capture an initial digital image of the beveled edge of the substrate, wherein the imaging system is a digital imaging system, which in some embodiments includes one or more image sensors. As per present disclosure, the digital imaging system includes a top edge sensor 402, a bottom edge sensor 403, an edge normal sensor 404, wherein the top edge sensor 402 includes a camera 408, the edge normal sensor 404 includes a camera 409, and the bottom edge sensor 403 includes a camera 410. The cameras 408, 409, and 410 can be coupled to the computer subsystem 405 by wires 414, 415, and 416. The motor 411 and the encoder 412 can be coupled to the computer subsystem 405 by wire 417. The various sensors 402, 403, and/or 404 are generally adapted to capture images of the substrate 401, such as grayscale and/or color image data for example. Additionally, it should be understood that in some embodiments, it is contemplated that the sensors 402, 403, 404 optionally operate according to a variety of principles or categories thereof, including for example, optical imaging, x-ray imaging, interferometric, Shack-Hartmann wavefront, and/or confocal principles.

In particular, in some embodiments, the substrate 401 is scanned from top, normal, and/or bottom directions in different angles using the edge sensors 402, 403, 404. In general terms, a “top-down” scan of the regions comprising of the substrate upper surface region 204 and substrate upper bevel region 205 (FIG. 2B) is performed via the top edge sensor 402, a “bottom-up” scan of the regions comprising of the substrate lower surface region 207 and the substrate lower bevel region 208 via the bottom edge sensor 403 and/or the substrate edge normal region 206 via the edge normal sensor 404. In some embodiments the sensors scan an edge portion of the substrate 401, the edge portion including one or more of the top edge region 204, the bottom edge region 207, and/or the substrate edge normal 206 by acquiring image data at a plurality of circumferential image frame locations about the substrate 401. Images are acquired in Brightfield illumination in some embodiments, although darkfield illumination, combinations of darkfield and brightfield illumination, and other imaging techniques such as those previously referenced are also contemplated.

The system 400 further comprises a processing circuitry that operates as part of the computer subsystem 405. The processing circuitry comprises a data acquisition module 405a, an image analysis module 405c, a control unit 405b and a storage unit 405d. The control unit 405b is configured to control the overall functioning of the system 400 as part of the processing circuitry. The computer subsystem 405 is configured to acquire image data of the substrate 401 and store in the storage unit 405d. The images acquired are a plurality of images taken about the region A and Region B or other edge portion of the substrate 401, with each of the plurality of images being acquired about the substrate 401. The top edge sensor 402 images the region A and Region B of the substrate 401 being substantially continuously rotated, for example in rotational direction R, such that images are acquired circumferentially about the substrate 401. Such images are optionally acquired substantially continuously, for example using a line scan camera such as a TDI camera. In some embodiments, the substrate 401 can also be rotated in a step-wise fashion. Alternatively, or additional, a strobe light or other appropriate means is optionally utilized to obtain images in a step-wise fashion while substantially continuously rotating the substrate 401. Other variations on continuous/step-wise image acquisition should be apparent in view of the foregoing. As referenced above, images of the substrate lower surface region 207, substrate lower bevel region 208 and the edge normal region 206 are alternately or additionally acquired about the substrate 401. In some embodiments, the images are typically taken about the circumference of the substrate 401, although images may also be taken partially about the substrate 401. Furthermore, in some embodiments, images are taken with some overlap in order to help ensure complete imaging or to otherwise increase image data resolution. However, non-overlapping images, separated images, and combinations thereof are also contemplated.

It should also be understood that, larger the substrate 401, the more images that will be used to image the substrate upper regions A and B or other region at a particular resolution. For example, a 300 mm diameter substrate is in comparison to a 200 mm diameter substrate will require a larger number of digital images to fully image the substrate upper regions A and B about the circumference of the substrate 401. Similarly, if a smaller substrate is used, such as 100 mm substrate, a smaller number of digital images are used to fully image the substrate upper regions A and B, for example, about the circumference of the substrate 401. Thus, various combinations of magnifications, substrate diameters, and numbers of images taken about the substrate upper regions A and B are also contemplated. In some embodiments, for a 200 mm substrate configuration, 128 digital images are acquired to help ensure substantially 360-degree coverage of images of the substrate upper regions A and B or other edge portions of the substrate 401, such as a substrate lower surface region 207 (or primary surface), a substrate lower bevel region 208 and an edge normal region 206. However, the top edge sensor 402 optionally acquires more numerous or less numerous images as desired, such as up to about 360 images or more. In some embodiments, the top edge sensor 402, for example, has a resolution of up to about 7 micrometers, although other resolutions including both higher and lower resolutions, are also contemplated. For example, a resolution of down to 1 micron, or even smaller such as 0.5 micron.

One, two, or any number of full passes around the substrate 401 can be completed with image data collected as desired at the various image frame locations. In some embodiments with two passes, the first pass is brightfield data, while the second pass is darkfield data. If desired, the substrate 401 is over turned or spun more than a single revolution in association with each full pass. For example, the substrate 401 is optionally spun 1.1 revolutions or 1.2 revolutions. As another example, the substrate 401 is optionally over turned more than 2 revolutions, such as 2.1 revolutions or 2.2 revolutions. Such overturning is optionally used in order to help ensure some overlap at a beginning and end of image acquisition, or to otherwise secure a desired amount of image information. It should also be understood that any number or fraction of additional/fewer passes are taken around the substrate 401 as desired.

The processing circuitry further comprises the image analysis module 405c which is configured to generate a filtered image according to the present disclosure. The filtered image is generated by filtering the initial digital image using a kernel having a shape substantially matching an expected shape of the beveled edge and identify a line in the filtered image representing the beveled edge by applying a line detection algorithm to the filtered image. As per present disclosure, the kernel is a one-dimension kernel, having between three and twenty elements of increasingly negative value The kernel filters the initial image of the bevel edge, by sliding over the image and scanning each pixel along with its adjacent pixels in each scan line present in the image. As per the present disclosure the kernel has a total negative value, which benefits in identifying areas of edge transitions based on pixel intensity variations. A significant contrast between the adjacent pixels where the pixel brightness drops or increases sharply is indicative of the presence of the bevel edge.

For each scan line of the initial image of substrate bevel edge, a kernel correlation is computed, which generates a series of correlation values across the image, in which the highest value indicates the location of the bevel edge. This allows accurate identification of the presence and location of the bevel edge based on the intensity variations highlighted by the customizable kernel. In some embodiments, the kernel is a first kernel, and for each scan line of the initial image, a respective correlation with each of a plurality of kernels including the first kernel. As per the present disclosure, the plurality of kernels differs in shapes, matching the various expected shapes of the bevel edge of the substrate, resulting in defined areas depicting the intensity variations indicative of the presence of the bevel edge.

As per present disclosure, a respective correlation for a respective kernel of the plurality of kernels is compared with the threshold value indicating a match to the respective kernel. The threshold value functions as a predetermined reference value for determining whether the correlation value for a particular kernel from the plurality of kernels matches the expected bevel edge characteristics. In one embodiment, if the comparison results in a higher correlation value, it indicates that the particular kernel matches the expected shape of the bevel edge of the substrate. Each of the kernel correlation is compared against the threshold value, to identify the specific kernel from the plurality of kernels which most accurately matches the expected shape of the bevel edge, thereby eliminating false positives and ensuring the reliability of the method.

In response to the comparison of a respective correlation for a respective kernel of the plurality of kernels with the threshold value, the image analysis module 405c, applies a line detection algorithm to the filtered image to identify a line representing the beveled edge in the filtered image. The line detection algorithm applied to the filtered image is Hough transform is configured to identify vertical lines representing the bevel edge in the filtered image. The Hough transform generates both a confidence value and location for each of the identified vertical or near vertical lines. Each of scan line in the filtered image contributes to a vote and the sum of votes for a line representing a bevel edge is to be nearly unanimous. In the presence of debris or any defect resulting in a significant deviation, the identified vertical line is ignored for subsequent steps of semiconductor fabrication.

In accordance with the embodiments of the present disclosure, processing circuitry is further configured to generate a report identifying defects in the substrate and locations of the defects relative to the beveled edge of the substrate. The report generated may include different types of visual and quantitative data providing comprehensive analysis relating to the location of bevel edge, distribution of defect types, confidence values for each of the identified vertical lines etc., in the form of histograms, charts or tables.

According to yet another aspect of the present disclosure, a computer readable storage medium storing processor-executable instructions configured to, when executed by at least one processor, cause performance of a method of detecting a presence and location of a beveled edge of a substrate, is disclosed. The method comprising receiving an initial image of the beveled edge of the substrate in digital form, at a semiconductor inspection tool. The method further comprising, generating a filtered image by filtering the initial image using a kernel by a processor of the semiconductor inspection tool, wherein the kernel has a shape substantially matching an expected shape of the beveled edge. Further, a line in the filtered image representing the beveled edge is identified by applying a line detection algorithm to the filtered image.

As used herein, the phrase “computer readable storage medium” may include any medium that is capable of storing, encoding, or carrying instructions for execution by the processor and that cause the processor to perform any one or more of the techniques of the present disclosure, or that is capable of storing, encoding or carrying data structures used by or associated with such instructions. Non-limiting computer readable storage medium examples may include solid-state memories, and optical and magnetic media. Specific examples of massed computer readable storage medium may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The computer readable storage medium storing processor-executable instructions configured to, when executed by at least one processor, cause performance of a method of detecting a presence and location of a beveled edge of a substrate. The method comprising receiving an initial image of the beveled edge of the substrate in digital form, at a semiconductor inspection tool. The inspection tool, can include a digital imaging system, which in some embodiments includes one or more image sensors. The image sensors present in the imaging system are any one or a combination of time delay integration (TDI) camera, area scan camera, hyperspectral camera or other sensor types as desired.

The computer readable storage medium storing processor-executable instructions configured to cause performance of the method comprising, generating, a filtered image by filtering the initial image using a kernel. The kernel performs image filtering by applying a mathematical operation to each pixel in the image and its neighbors. As per one embodiment of the present disclosure, the kernel used for generating the filtered image is a customizable kernel for performing one-dimensional convolution operation. The kernel may be modified in terms of its size, shape, and values, depending on the desired result. In accordance with the embodiments of the present disclosure, the kernel is adjusted to highlight specific features such as transitions or edges in the initial image of the substrate, based on subtle variations in pixel intensity in the bevel edge portion. In an example embodiment, the kernel may have a total negative value, which is used for detecting bevel edges by highlighting areas of transitions having sharp contrast.

In accordance with the present disclosure, the kernel is a one-dimension kernel, having between three and twenty elements of increasingly negative value. The kernel filters the initial image of the bevel edge, by sliding over the image and scanning each pixel along with its adjacent pixels in each scan line present in the image. As per the present disclosure the kernel has a total negative value, which benefits in identifying areas of edge transitions based on pixel intensity variations. A significant contrast between the adjacent pixels where the pixel brightness drops or increases sharply is indicative of the presence of the bevel edge.

In one embodiment of the present disclosure, the kernel has a shape substantially matching an expected shape of the beveled edge. The kernel has a series of values designed to match the shape of the expected transition indicating the bevel edge. This is particularly beneficial, in cases of considerable ambiguity in pixel variations representing the edge transitions, the customizable kernel can flexibly accommodate these variations while still accurately defining the transition point. As per the present disclosure, the transition is from the brighter intensities of the surface into either darker intensity in the bevel, or a fade to black when the bevel is not imaged, the kernel starts with more positive and increasingly negative values. The total value of the kernel is maintained negative to suppress the random variations in the field of the surface.

The computer readable storage medium storing processor-executable instructions configured to cause performance of the method comprising, generating the filtered image further includes computing a correlation with the kernel, for each scan line of the initial image. The computed correlation is a measure of degree of similarity between the kernel and the specific area in the image. The correlation value is higher (in magnitude) when the kernel matches with the area of the image which has an identifiable transition, indicative of the presence of the bevel edge. As per the present disclosure, the correlation value is computed for each scan line, generating a series of correlation values across the image, in which the highest value indicates the location of the bevel edge. This allows the method to accurately identify the presence and location of the bevel edge based on the intensity variations highlighted by the customizable kernel.

In accordance with the present disclosure, the filtered image generated using the one-dimensional kernel has highlighted values for a region of significant intensity variations, while the other areas with random intensity variations are considered as zero and suppressed. In a beneficial embodiment, the filtered image contains largely zero-valued pixels, except for a bright, often saturated line with significant intensity variation, that corresponds to the transition region with a slope which is identified as the bevel edge.

In some embodiments, the kernel is a first kernel, and wherein the method further comprises computing, for each scan line of the initial image, a respective correlation with each of a plurality of kernels including the first kernel. As per the present disclosure, the plurality of kernels differs in shapes, matching the various expected shapes of the bevel edge of the substrate, resulting in defined areas depicting the intensity variations indicative of the presence of the bevel edge.

The computer readable storage medium storing processor-executable instructions configured to cause performance of the method of detecting the presence and location of a beveled edge of a substrate further comprises of comparing a respective correlation for a respective kernel of the plurality of kernels with the threshold value indicating a match to the respective kernel. As per the present disclosure, subsequent to computing a respective correlation with each of a plurality of kernels for each scan line of the initial image, each respective correlation for a respective kernel of the plurality of kernels is compared with a threshold value. The threshold value functions as a predetermined reference value for determining whether the correlation value for a particular kernel from the plurality of kernels matches the expected bevel edge characteristics. In certain embodiments, if the comparison results in a higher correlation value, it indicates that the particular kernel matches the expected shape of the bevel edge of the substrate. Each of the kernel correlation is compared against the threshold value, to identify the specific kernel from the plurality of kernels which most accurately matches the expected shape of the bevel edge.

The computer readable storage medium storing processor-executable instructions configured to cause performance of the method comprising, identifying, with the processor, a line in the filtered image representing the beveled edge by applying a line detection algorithm to the filtered image. The line detection algorithm applied to the filtered image is Hough transform is configured to identify vertical lines representing the bevel edge in the filtered image. The Hough transform generates both a confidence value and location for each of the identified vertical or near vertical lines. Each of scan line in the filtered image contributes to a vote and the sum of votes for a line representing a bevel edge is to be nearly unanimous. In the presence of debris or any defect resulting in a significant deviation, the identified vertical line is ignored for subsequent steps of semiconductor fabrication, the processor-executable instructions are further configured to cause the performance of the method to include repeating the method at hundreds of locations around a perimeter of the substrate.

In accordance with the embodiments of the present disclosure, the computer readable storage medium storing the processor-executable instructions are further configured to cause the performance of the method to include generating a report identifying defects in the substrate and locations of the defects relative to the beveled edge of the substrate. Furthermore, the method is repeated at hundreds of locations around a perimeter of the substrate, ensuring accuracy and redundancy of the method.

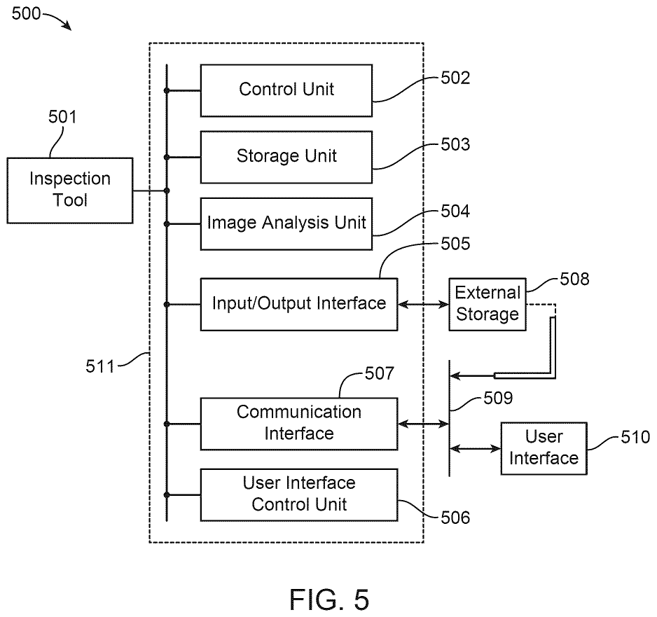

FIG. 5, illustrates an example computer readable storage medium storing processor-executable instructions configured to, when executed by at least one processor, cause performance of a method of detecting a presence and location of a beveled edge of a substrate 500. The method of processing an image of a substrate to identify defects in the substrate is implemented as computer subsystem 511. The computer subsystem 511, is configured to provide the functionality described herein. In embodiments, the computer subsystem 511 can be a server and/or other computing device that performs the operations discussed herein, such as the classifying defect operations as described herein.

The computer subsystem 511 includes a control unit 502, a storage unit 503, an image analysis unit 504, an input/output interface 505, a communication interface 507, a user interface control unit 506, and the like. These components are communicatively coupled to each other via a bus. The computer subsystem 511 includes at least one processor circuitry comprising a control unit 502 and image analysis unit 504. The control unit 502 corresponds to a controller that controls the whole. The control unit 502 includes, for example, a hardware circuit or a processor such as a CPU, MPU, or GPU. If the control unit 502 has a processor such as a CPU, the processor executes processing according to a program read from the storage unit 503. The control unit 502 implements various functions based on program processing, for example. The image analysis unit 504 is configured with, for example, a CPU, MPU, GPU, or the like, and a memory such as ROM or RAM. The image analysis unit 504 performs the method according to the program read from the storage unit 503 by the processor. Note that the control unit 502 and the image analysis unit 504 may be integrated. The image analysis unit 504 is configured to generate a filtered image by filtering the initial digital image using a kernel having a shape substantially matching an expected shape of the beveled edge and identify a line in the filtered image representing the beveled edge by applying a line detection algorithm to the filtered image.

The storage unit 503 may store one or more sets of data structures or instructions (e.g., software or firmware) embodying or utilized by any one or more of the techniques or functions described herein. The instructions may also reside, completely or at least partially, within a main memory, within a volatile memory, within a non-volatile memory, or within the hardware-based processor during execution thereof by the computer subsystem 511. In an example, one or any combination of the hardware-based processor, the main memory, the volatile memory, and the non-volatile memory may constitute computer-readable media. While the computer-readable medium is considered as a single medium, the term “computer-readable medium” may include a single medium or multiple media (e.g., a centralized or distributed database, and/or associated caches and servers) configured to store the one or more instructions.

The storage unit 503 (removable, and/or non-removable) including, but not limited to, solid-state devices, magnetic or optical disks, or tape. Data such as programs read from the external storage 508 or the communication network 509 may be stored in the storage unit 503. The storage unit 503 may store the image data obtained from the inspection tool 501 for image analysis.

The communication interface 507 is a communication interface compatible with the communication network 509 such as local-area network (LAN), wide-area network (WAN), point-to-point, Bluetooth, RF, etc., may also be incorporated into the computer subsystem 511, to transmit and receive data and information to and from the communication network 509. Computer subsystem 511 is connected to communication network 509 through communication interface 507. The computer subsystem 511 can be connected to and communicate with external systems and devices via a communication network 509.

Further, the computer subsystem 511 may also have user interface 510 controlled by a user interface control unit 506. The user interface 510 comprises, input device(s) such as touch screens, keyboard, mouse, pen, voice input, etc., and/or output device(s) such as a display, printer, etc. A user terminal and other input/output devices may be part of the computer subsystem 511. Other input/output devices such as a display device, an audio output device, and an operation device may be connected to the input/output interface 505 or the user interface control unit 506. Further, while only a single computer subsystem is illustrated, the term “computer subsystem” shall also be taken to include any collection of computer subsystems that individually or jointly execute a set (or multiple sets) of instructions to perform any one or more of the methodologies discussed herein, such as cloud computing, software as a service (SaaS), or other computer cluster configurations.

The present method and system as disclosed herein, effectively enables detecting the presence and location of a beveled edge of a substrate even in the presence of ambiguities like noise or debris, eliminating errors and false detection rates, and thereby ultimately improve the efficiency and reliability of semiconductor fabrication processes.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurement techniques utilized herein. To the extent such terms may not be clearly defined or understood by one having skill in the art, the term “about” shall mean plus or minus ten percent.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A method of detecting a presence and location of a beveled edge of a substrate, comprising:
moving the substrate in an inspection tool;
capturing, at the inspection tool and in digital form, an initial image of the beveled edge of the substrate;
generating a filtered image by filtering the initial image using a kernel having a shape substantially matching an expected shape of the beveled edge; and
identifying a line in the filtered image representing the beveled edge by applying a line detection algorithm to the filtered image.

2. The method of claim 1, wherein applying the line detection algorithm comprises applying a Hough Transform to the filtered image, the Hough transform configured to identify vertical lines in the filtered image.

3. The method of claim 1, wherein the kernel has a total value that is negative.

4. The method of claim 1, wherein the kernel is a first kernel, and wherein the method further comprises computing, for each scan line of the initial image, a respective correlation with each of a plurality of kernels including the first kernel.

5. The method of claim 4, wherein the kernels of the plurality of kernels differ in shape.

6. The method of claim 4, further comprising comparing each respective correlation with a threshold value, and wherein applying the line detection algorithm is performed in response to a comparison of a respective correlation for a respective kernel of the plurality of kernels with the threshold value indicating a match to the respective kernel.

7. The method of claim 1, further comprising repeating the method at hundreds of locations around a perimeter of the substrate.

8. The method of claim 1, wherein the kernel is a one-dimensional kernel having between three and twenty elements of increasingly negative value.

9. The method of claim 1, further comprising generating a report identifying defects in the substrate and locations of the defects relative to the beveled edge of the substrate.

10. The method of claim 1, wherein receiving, at the inspection tool and in digital form the initial image of the beveled edge of the substrate comprises capturing the initial image with an imaging system of the inspection tool.

11. The method of claim 1, wherein generating the filtered image comprises computing, for each scan line of the initial image, a correlation with the kernel.

12. A computer readable storage medium storing processor-executable instructions configured to, when executed by at least one processor, cause performance of a method of detecting a presence and location of a beveled edge of a substrate, the method comprising:
receiving, at a semiconductor inspection tool and in digital form, an initial image of the beveled edge of the substrate;
generating, by a processor of the semiconductor inspection tool, a filtered image by filtering the initial image using a kernel having a shape substantially matching an expected shape of the beveled edge; and
identifying, with the processor, a line in the filtered image representing the beveled edge by applying a line detection algorithm to the filtered image.

13. The computer readable storage medium of claim 12, wherein applying the line detection algorithm comprises applying a Hough Transform to the filtered image, the Hough transform configured to identify vertical lines in the filtered image.

14. The computer readable storage medium of claim 12, wherein the kernel has a total value that is negative.

15. A system for detecting a presence and location of a beveled edge of a substrate, comprising:
a substrate moving mechanism;
an imaging system configured to capture an initial digital image of the beveled edge of the substrate; and
processing circuitry configured to:
receive the initial digital image;
generate a filtered image by filtering the initial digital image using a kernel having a shape substantially matching an expected shape of the beveled edge; and
identify a line in the filtered image representing the beveled edge by applying a line detection algorithm to the filtered image.

16. The system of claim 15, wherein applying the line detection algorithm comprises applying a Hough Transform to the filtered image, the Hough transform configured to identify vertical lines in the filtered image.

17. The system of claim 15, wherein the kernel has a total value that is negative.

18. The system of claim 15, wherein the kernel is a first kernel, and wherein the processing circuitry is further configured to compute, for each scan line of the initial image, a respective correlation with each of a plurality of kernels including the first kernel.

19. The system of claim 18, wherein the kernels of the plurality of kernels differ in shape.

20. The system of claim 18, wherein the processing circuitry is further configured to compare each correlation with a threshold value, and wherein applying the line detection algorithm is performed in response to a comparison of a respective correlation for a respective kernel of the plurality of kernels with the threshold value indicating a match to the respective kernel.

21. The system of claim 15, wherein the kernel is a one-dimensional kernel having between three and twenty elements of increasingly negative value.

22. The system of claim 15, wherein the processing circuitry is further configured to generate a report identifying defects in the substrate and locations of the defects relative to the beveled edge of the substrate.
